(19) United States
(12) Patent Application Publication
(10) Pub. No.: US 2008/0183663 A1
(43) Pub. Date: Jul. 31, 2008

(54) Dynamic Index Selection for Database Queries

(76) Inventors: Paul Reuben Day, Rochester, MN (US); Brian Robert Muras, Rochester, MN (US)

Correspondence Address: IBM CORPORATION (SS/ROC);c/o STREETS & STEELE, 13831 NORTHWEST FREEWAY, SUITE 355, HOUSTON, TX, 77040, US

(21) Appl. No.: 11/669,728

(22) Filed: Jan. 31, 2007

(51) Int. Cl. G06F 17/30

(52) U.S. Cl. 707/2; 707/E17.014

(57) ABSTRACT

Methods are provided for dynamically selecting indexes during the execution of a database query, to optimize performance. In one embodiment, a query is provided for joining a target table and a source table. Rows of the target table are selected that simultaneously satisfy at least first and second criteria. The first criterion specifies values of a first column of the target table as a function of values of a first column of the source table and the second criterion specifies values of a second column of the target table as a function of values of a second column of the source table. A plurality of indexes are generated, including at least a first index using the first column of the target table and a second index using the second column of the target table. Rows of the source table are selected and, for each selected row, the first index is probed to determine how many rows of the target table satisfy the first criterion, and the second index is probed to determine how many rows of the target table satisfy the second criterion. One of the indexes is selected according to how many rows are determined to satisfy the first and second criteria. Typically, the index pointing to fewer satisfied rows is selected. The index may be switched as needed throughout the execution of the query, to optimize performance and efficiency.

### BACKGROUND OF THE INVENTION

1. Field of the Invention

The present invention relates to methods of querying a database, and, more particularly, to methods of improving the efficiency of performing database queries in a database management system.

2. Description of the Related Art

A database may be described as a collection of records stored in a computer in tabular form for subsequent searching. A computer program referred to generally as a “database management system” (DBMS) may be used to search one or more database tables in response to queries. A table is generally organized into “columns” and “rows.” A column of a database table is a set of data values of a particular type. A row in a database is sometimes referred to as a record, and represents a set of related data. The intersection between a row and a column may be referred to as a field, containing a value. For example, an employee database may contain data organized into columns such as a Last Name column, a Position Title column, and a Date of Hire column, with each row relating this data for a different employee.

An index is used to access rows having specified values. An index is typically a set of values found in a particular column along with row identifiers or “pointers” that point to rows in the table that contain each of those values. Using an index to first determine which rows of the table contain the specified values is more efficient than searching all of the records in the table for rows containing the specified values. Multiple indexes are usually available from which to choose, and some DBMS applications attempt to select the index that provides the best performance from among the available indexes. However, conventional index selection is after selecting an index, a conventional DBMS will run the entire query using the selected index. The available indexes are often all suboptimal, so that even the best available index may result in suboptimal performance.

In view of the shortcomings of conventional database query methods, an improved method of searching a database is needed. The method would preferably minimize runtime costs and system resources, as well as produce faster search results.

### SUMMARY OF THE INVENTION

The invention includes methods for selecting an index while executing a database query. In a first embodiment, a target table and a source table are provided. A query is provided for selecting rows of the target table that simultaneously satisfy first and second criteria, wherein the first criterion specifies values of a first column of the target table and the second criterion specifies values of a second column of the target table. A plurality of indexes are generated, including at least a first index using the first column of the target table and a second index using the second column of the target table. For each row of the source table, the first index is probed to determine a number of rows of the target table that satisfy the first criterion, the second index is probed to determine a number of rows of the target table satisfy the second criterion. The first and second indexes are dynamically switched while executing the query according to the number of rows of the target table that satisfy the first criterion and the number of rows of the target table that satisfy the second criterion.

In a second embodiment, the method of the first embodiment may be performed, at least in part, by a computer program product comprising a computer usable medium including computer usable program code for performing the steps of the method.

In a third embodiment, a target table and a source table are provided. A query is provided for selecting rows of the target table that simultaneously satisfy first and second criteria, wherein the first criterion specifies values of a first column of the target table and the second criterion specifies values of a second column of the target table. A plurality of indexes is generated, including at least a first index using the first column of the target table and a second index using the second column of the target table. For each row of the source table, the first index is probed to determine a number of rows of the target table that satisfy the first criterion, the second index is probed to determine a number of rows of the target table that satisfy the second criterion, and one of the first and second indexes is selected for which fewer rows satisfy the respective one of the first and second criteria. For each row of the source table, table operations specified by the query may be performed using the selected index.

In a fourth embodiment, a target table and a source table are provided. A query is provided for selecting rows of the target table that simultaneously satisfy first and second criteria, wherein the first criterion specifies values of a first column of the target table and the second criterion specifies values of a second column of the target table. A plurality of indexes are generated, including at least a first index using the first column of the target table and a second index using the second column of the target table. For each row of the source table, the first index is probed to determine a number of rows of the target table that satisfy the first criterion, the second index is probed to determine a number of rows of the target table satisfy the second criterion, and one of the first and second indexes is selected for which fewer rows satisfy the respective one of the first and second criteria. For each row of the source table, rows of the target table are selected according to the query using the selected index.

Other embodiments, aspects, and advantages of the invention will be apparent from the following description and the appended claims.

### BRIEF DESCRIPTION OF THE DRAWINGS

FIG. 1 is a diagram illustrating various objects of a database, including a Table X, Table Y, Y's Index over C1, and Y's Index over C2.

FIG. 2 is a flowchart outlining a method for searching a database according to the invention, wherein first and second indexes are probed in series.

FIG. 2A is a flowchart outlining a variation of the method of FIG. 2, wherein the first and second indexes are probed in parallel.

FIG. 3 is a schematic diagram of a computer system that may be configured for running a DBMS software application capable of querying a database according to the invention.

### DETAILED DESCRIPTION OF PREFERRED EMBODIMENTS

The present invention provides methods for more efficiently searching a database using dynamic index selection. A database management system is no longer limited to the use of a single index (or a single bitmap index created from multiple indexes) for the duration of performing a query. Rather, the DBMS may continuously evaluate the available indexes and switch indexes as needed during execution of the query, to use the best available index at any given stage of the query. Dynamic index selection results in faster query runtime and greatly reduces the use of system resources such as memory. The invention is particularly useful when executing queries that require an index for a secondary file of a join operation. Performance may also be enhanced when executing a scalar subselect, a “derived” table or “common” table expression, user defined functions, SQL stored procedures, and subqueries.

In one embodiment, at least two tables are provided in a database management system. One table is designated by the DBMS as the “target table” and the other is designated the “source table”. Typically, the target table and source table are two different tables, such as two tables to be joined, although in special cases (such as in a scalar subselect) the target and source tables may be the same. The terms “target table” and “source table” are used for the purpose of discussing the invention herein, and are not terms of art. However, these terms may be described with reference to a “join position,” which is a term commonly used in the art. In the case of a join, as discussed herein, the source table is in join position 1, and the target table is in join position 2. The DBMS may switch the join positions to optimize the query, and re-designate the tables to different join positions if needed. The join position is typically determined by a query optimizer according to techniques known in the art.

A query is provided for searching the database. For example, the source table may be X, the target table may be Y, and the query may be SELECT * FROM X,Y, WHERE X.C1=Y.C1 AND X.C2=Y.C2. The query is structured to select rows of the target table that simultaneously satisfy at least first and second criteria (and possibly additional criteria, as well). The first criterion specifies values of a first column of the target table as a function of values of a first column of the source table. The second criterion specifies values of a second column of the target table as a function of values of a second column of the source table. In the above example, the criterion X.C1=Y.C1 may be designated as the first criterion, and the criterion X.C2=Y.C2 may be designated as the second criterion.

A plurality of indexes of the target table are generated, and the DBMS is configured to dynamically select the best index at any given stage of the query's execution. The plurality of indexes include at least a first index and a second index. The first index uses the first column of the target table and the second index uses the second column of the target table. In executing the query, rows of the source table are selected and relevant values of the selected rows are sequentially “fed” or “input”, row-by-row, to the query to be evaluated. For each selected source table row, the plurality of indexes are probed to determine how many rows of the target table would be returned. The first index is probed to determine how many rows of the target table satisfy the first criterion, the second index is probed to determine how many rows of the target table satisfy the second criterion, and so forth, for as many indexes (and criterion) are available to choose from. For each row of the source table input to the query, the best index is typically the index that points to the fewest rows of the target table that satisfy the respective one of the plurality of criteria. However, the analysis of which index is “best” may include certain stipulations for optionally shortcutting the need to evaluate every index for every row. For example, if the first index evaluated returns very few rows (as may be determined by a predetermined setpoint), then the first index may be selected by default, without needlessly evaluating the remaining indexes. Other possible selection factors are examined further below.

Once an index is selected, the rows of the target table pointed to by the selected index as satisfying the respective one of the plurality of criteria are searched to identify the rows of the target table that also satisfy the remaining criteria in the query. The subset of rows of the target table that satisfy all of the criteria set forth in the query may be ascertained, and operated upon as specified by the query. The process is repeated for each row of the source table whose values are input to the query. Thus, the index to be selected and used may be switched as needed during execution of the query. This embodiment illustrates one example of how dynamic index selection according to the invention may be used to optimize performance.

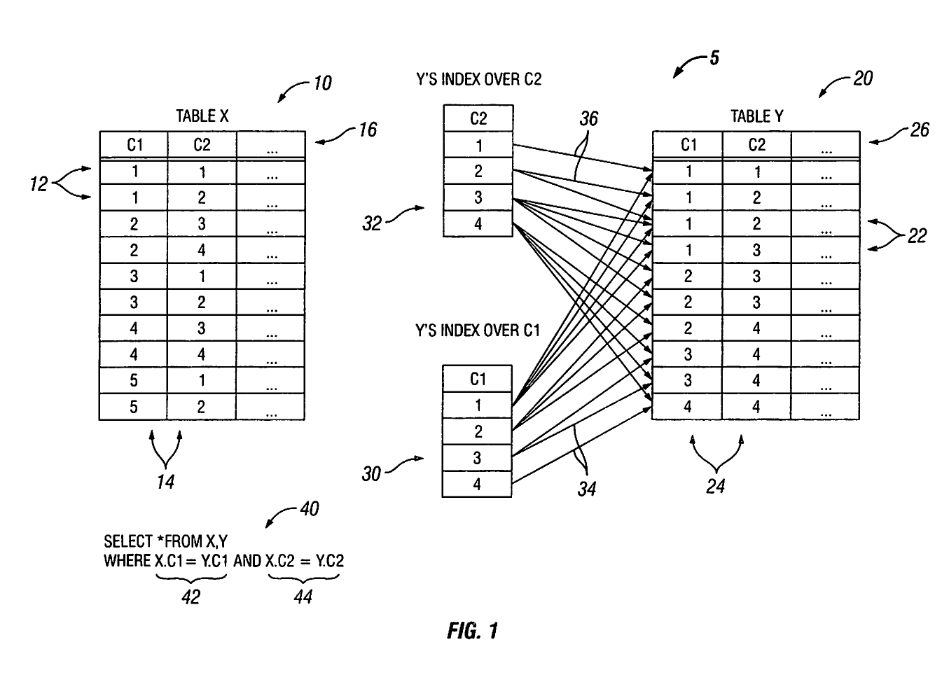

FIG. 1 is a diagram illustrating various objects of a database 5, including two tables 10, 20 labeled “Table X” and “Table Y,” a first index 30 labeled “Y's Index over C1,” and a second index 32 labeled “Y's Index over C2.” The tables 10, 20 and indexes 30, 32 depict how a portion of the database may be structured. The tables 10, 20 may even be displayed in a similar fashion on the display of a user interface, such as on a video monitor connected to a computer on which database management software is run. However, the contents of tables 10, 20 are stored and manipulated on a computer electronically and generally exist independently from any visual attributes shown in the figure, such as the ordered spatial positioning of data in a rectangular grid fashion with text labels. Thus, the visual attributes of the tables 10, 20 and indexes 30, 32 are provided to facilitate an understanding and discussion of how the database may be structured, while maintaining the breadth of what is generally known in the art as a “table.”

Table X includes a plurality of rows 12 and a plurality of columns 14. Each column 14 of Table X is a set of data values of a particular type, as labeled by column headers 16. The columns 14 of Table X include a first column C1 and a second column C2. Likewise, Table Y includes a plurality of rows 22 and a plurality of columns 24 with column headers 26. The columns 24 of Table Y include a first column C1 and a second column C2. To simplify illustration, the first and second columns C1 and C2 are labeled as such, and happen to be the first two columns of Table Y. It should be recognized, however that the adjectives “first” and “second” may be used generally to identify and distinguish between any two selected columns of a table without signifying their order or positioning within a table. It should also be recognized that the tables may include any number of additional rows and columns.

The indexes 30, 32 may be designated as a “first index” 30 and a “second index” 32. The first index 30 (Y's Index over C1) includes a set of values found in the first column C1 of table 20 (Table Y), along with row identifiers or “pointers” 34 that identify or “point to” the rows 22 in the table 20 that contain each of those values. The second index 32 (Y's Index over C2) includes a set of values found in the second column C2 along with row identifiers or “pointers” 36 that identify or “point to” the rows 22 in the table 20 that contain each of those values in the second column C2. The indexes 30, 32 may be used to determine which rows of the table contain specified values in the respective first and second columns C1, C2, which is more efficient in terms of factors such as runtime and memory than searching all of the records in the table 20 for rows containing the specified values. For example, to find rows of Table Y for which C1=1, Y's Index over C1 may be consulted to find four of the pointers 34 that point to rows containing that value. Using the index 30, therefore, avoids the need to search all of the rows 22.

A query 40 is used for executing a search within the database of FIG. 1. A variety of query languages and protocols are widely known in the art and need not be explained here in exhaustive detail. Generally, a query may take the form of a command or search string for extracting selected information from the database or performing selected computations or operations on the data. The query 40 may be entered into a DBMS in a variety of formats. A query may be entered by a user via a user interface and input in a variety of formats, such as in a structured query entry form or in a non-structured or “free form” query format. Alternatively, a query may be embedded within structured query language (SQL) and executed by a DBMS. The exemplary query 40 is configured to search Table X and Table Y for rows in which two criteria are satisfied. A first criterion 42 (X.C1=Y.C1) stipulates that the value in column C1 from Table X equals the value in column C1 from Table Y. A second criterion 44 (X.C2=Y.C2) stipulates that the value in column C2 from table X equals the value in column C2 from Table Y. The adjectives “first” and “second” may be generically used to distinguish the two criterion 42, 44, and do not necessarily imply any order, hierarchy, priority or preference between the two criterion 42, 44. The query 40 instructs the DBMS to select (retrieve) all values in those rows in which both criteria 42, 44 are satisfied.

An example of “static” index selection using a conventional method is given to provide context. In this example, a conventional DBMS would execute the query 40 by selecting only one of the indexes 30, 32 to run the entire query 40. If Y's Index over C1 were selected, for example, Y's Index over C1 could be used to plug in values of Y(C1) to the first criterion 42. Taking each row of Table (1,1), the conventional DBMS would “probe” (i.e. inspect) Y's Index over C1 to find rows satisfying the first criterion 42. For the first row of X (X.C1=1, Y.C1=1) the conventional DBMS would probe Y's Index over C1 to find rows of Y wherein Y.C1=1. There are four pointers 34 pointing from the index 30 to rows of Table Y for which C1=1. The conventional DBMS would then access those four rows from Table Y for further searching to identify rows having Y.C2=1. The next row of X (1,2) would similarly cause Table Y to be touched 4 times, because the same index 30 is used with the same Y.C1=1. When the query has been executed for all the rows of Table X, Table Y will have been touched a total of 4+4+3+3+2+2+1+1+0+0=20 times. Similarly, if the conventional DBMS had instead picked the index 32 (Y's Index over C2), Table Y would have been touched a total of 1+2+3+4+1+2+3+4+1+2=23 times. Thus, using Y's Index over C1 would be slightly more efficient than using Y'S Index over C2 for the query 40. However, neither index 30, 32 alone can provide the level of performance and efficiency provided by the present invention. The static selection and use of a single index (or a single bitmap index created from multiple indexes) results in suboptimal performance.

By contrast, the present invention significantly enhances the speed and efficiency of executing a query by allowing dynamic sampling, selection, and switching between the two indexes 30, 32, as needed. According to the invention, the above query could instead be performed as follows. For the first row of X (1,1), Y's Index over C1 may be probed to determine that four rows of Table Y satisfy the first criterion X.C1=Y.C1. Likewise, Y's Index over C2 may also be probed to determine that only one row of Table Y satisfies the criterion X.C2=Y.C2. Thus, without yet touching Table Y, it may be determined that selecting Y's Index over C1 would require searching four rows to determine which of those rows also satisfy the second criterion X.C2=Y.C2, whereas selecting Y's Index over C2 would only require searching one row to determine whether that one row also satisfies the first criterion X.C1=Y.C1. Therefore, Y's Index over C2 would be selected and used to search Table Y for rows having the same values as the first row of Table X (1,1). Repeating this approach for the remaining rows of Table X, executing the entire query 40 would require touching Table Y only 1 (Index 32)+2 (Index 32)+3 (Index 30 or 32)+4 (Index 30)+1 (Index 32)+2 (Index 30 or 32)+1 (Index 30)+1 (Index 30)+0 (Index 30)+0 (Index 30)=14 times.

“I/Os” to a table typically involve reading one or more rows of a table into RAM/memory, and inspecting the one or more rows with a processor. A database table can be very large, potentially comprising gigabytes of data, which is typically many orders of magnitude larger than an index to the same database table. Furthermore, RAM and processor bandwidth is typically crowded by other data and operations, so memory and processor bandwidth are at a premium. Due to the comparatively large size of a table, therefore, I/Os to a table are usually the most computationally expensive part of executing a query. According to the invention, indexes may be “touched” (accessed) more times than with conventional methods of performing a database query. Though accessing an index has a cost, the increased cost of touching more indexes is more than offset by the cost savings associated with accessing a table many fewer times according to the invention. Indexes are much smaller than a table, and multiple indexes will fit more easily into memory than a large table or portions thereof. Also, values may be located without scanning the entire index.

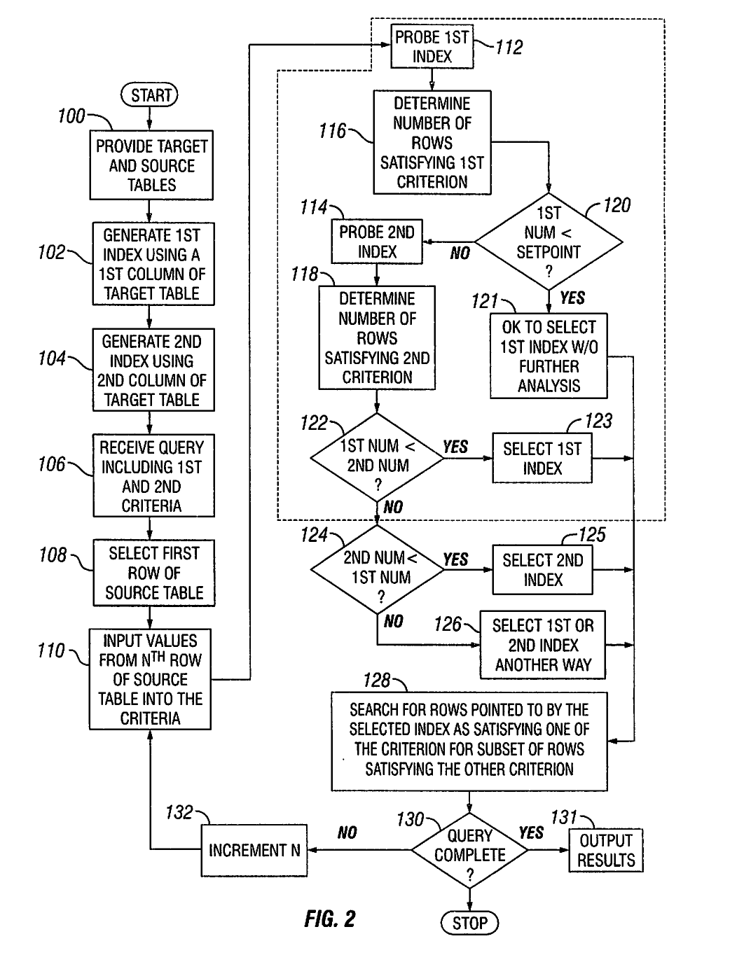

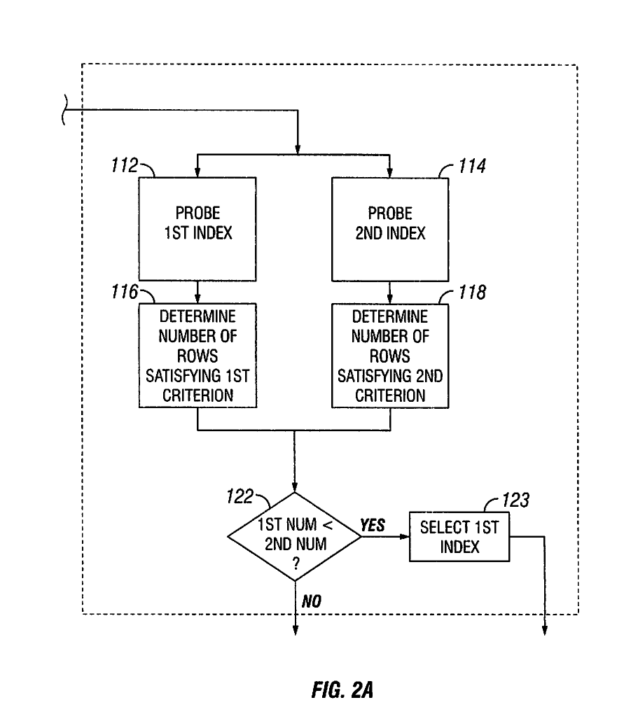

FIG. 2 is a flowchart outlining a method for searching a database according to the invention. Multiple tables are typically provided, including at least one table provided in step 100. The table selected in step 100 may be referred to as the “target table.” The target table has a plurality of rows and columns, and multiple indexes are generated for the target table. A “first index” is generated in step 102. The first index uses at least one of the columns of the target table, which will be referred to as the “first column.” A “second index” is generated in step 104. The second index uses at least one other column of the target table, which will be referred to as the “second column.” The first index is typically an ordered listing of the values that appear in the first column, along with row identifiers (“pointers”) that identify (“point to”) rows of the target table containing those values in the first column. Likewise, the second index is typically an ordered listing of the values that appear in the second column, along with pointers that point to rows of the table that contain those values in the second column.

Techniques known in the art may alternatively be used to generate the first and second indexes as functions or expressions of the first and second columns. Other techniques known in the art may be used to generate the first and second indexes from multiple columns that include the first and second column. For example, the query statement “SELECT * FROM X, Y WHERE X.F1=Y.F1 AND X.F2=Y.F2 AND X.F3=Y.F3” could be executed using a first Y index over (F1, F2) and a second Y index over (F2, F3). The first criteria would be X.F1 =Y.F1 and X.F2=Y.F2. The second criteria would be X.F2=Y.F2 and X.F3=Y.F3. The two indexes each use two columns. The two indexes have columns F2 in common. However, column F1 is uniquely used by the first index and column F3 is uniquely used by the second Y index. Thus, in the context of the invention the column F1 may be the “first column,” used by the first index, and column F3 may be the “second column,” used by the second index. Generalizing from this example, it may be observed that the use of a first column by a first index and the use of a second column by a second index does not limit the first and second indexes to only one column each.

In step 106, a query is received for searching the database, according to any of a variety of query formats known in the art. For example, the query may be entered into a DBMS by a user via a user interface in a variety of formats, such as in a structured query entry form or in a non-structured or “free form” query format. Alternatively, the query may be embedded within structured query language (SQL) and executed by a DBMS. The query received in step 106 may be fairly complex, potentially involving many different criteria to be satisfied. Satisfying the criteria of the query may require many different operations to be performed on the table provided in step 100, alone or in combination with many other tables. At a minimum, however, the query will involve at least two criteria, designated as a “first criterion” and a “second criterion.” The first criterion will reference the first column of the target table and the second criterion will reference the second column of the target table.

Rows of the source table are examined to determine the best index to use with each row. The source table rows may be examined sequentially (in series), or simultaneously (in parallel) by the DBMS. For simplicity, the flowchart describes a sequential process of examining N rows of the source table, beginning with a “first row” in step 108. The first row examined is not necessarily the uppermost row of the source table. In step 110, the first and second criteria are examined using relevant values of the Nth row to determine which target table index to select. The relevant values of the Nth row are plugged into the criteria. For example, if the first criterion is the expression X.C1=Y.C1 and the second criterion is the expression X.C2=Y.C2, the relevant values to be plugged in to these expressions are the values from the Nth row, columns C1 and C2 of the source table (Table X). The first index is probed in step 112. Since the relevant values of the nth row of the source table have already been input into the criteria, the number of rows of the target table that satisfy the first criterion for the relevant values is determined in step 116. Conditional step 120 then compares the number of target table rows determined in step 116 to a predetermined setpoint to determine whether the second index also needs to be probed. The setpoint is usually a number of rows that is small enough to justify selection of that first index without further analysis. Thus, if the number of rows determined in step 116 is less than the setpoint, then the first index is selected without further analysis in step 121. It is assumed that the added work of probing the second index will not produce any significant reduction in the number of target table rows. Alternatively, the dynamic index sampling and selection algorithm might only be initiated if a high enough “fanout” is encountered, such as if the number of rows determined to satisfy the first criterion in step 116 exceed 100 rows (setpoint=100) or exceed a predetermined percentage of rows in a given table.

If the first number of rows determined in step 116 instead exceeds the setpoint (step 120), then the second index may be probed and compared to the first index. The second index is then probed in step 114 and the number of target table rows that satisfy the second criterion (when the relevant values of the nth source table row are input) is determined accordingly in step 118. It is desirable to select the one of the first and second indexes for which the smaller number of rows was determined to satisfy the respective one of the first and second criteria in steps 116 and 118. The conditional steps 120, 122, 124 may be used to select an index by comparing the number of rows determined by the first index to satisfy the first criterion in step 116 (“first number”) with the number of rows determined by the second index to satisfy the second criterion in step 118 (“second number”). In conditional step 122, the first number may be compared to the second number, and if the first number is less than the second number then the first index is selected in step 123. In conditional step 124 the first number may be compared to the second number, and if the first number is greater than the second number then the second index is selected in step 125. Another possibility is that the first number and second number are equal. For example, the first index may indicate that four rows satisfy the first criterion, while the second index indicates that four rows satisfy the second criterion. If this occurs, the first or second index may be selected in another way according to step 126. A simple tiebreaker method may be implemented to arbitrarily select one of the indexes, on the assumption that use of either index will yield similar results. Alternatively, the index which points to the most table pages already in memory may be selected. Another option is to select the index with the smaller byte-size. A tiebreaker-type selection may also be applied when the first and second number are substantially equal. For example, if probing the first index points to 900,000 rows and probing the second index points to 899,000 rows, the two numbers may be deemed substantially equal, or varying with a given percentage, in that selecting the smaller number may not appreciably shorten execution of the query.

In step 128, after one of the indexes is selected for a given set of values, the subset of table rows pointed to by the selected index may be further searched to complete to the query for the given set of values. If the first index was selected, then the subset of rows pointed to by the first index as satisfying the first criterion may be searched to find rows that also satisfy the second criterion. For example, the first index may point to four rows of a 100 row table satisfying the first criterion. Any number (0-4) of that subset of rows may satisfy the second criterion. This is much faster than without using an index, which would typically require searching all 100 rows of the table for rows that satisfy both the first and second criterion.

The flowchart in FIG. 2 is structured as a loop for evaluating the N rows of the source table, the steps of which may be repeated for each row as described above. In step 130, if the query is not yet complete (not all of the N rows have been examined yet), then the next row may be selected (N is incremented) in step 132. Returning to step 110, the relevant values from the current (Nth) row of the source table may be selected. Steps 112 through 128 may then be repeated, probing the first and second indexes (steps 112, 114), determining the number of rows satisfying the first and second criterion (steps 116, 118), selecting an index (steps 120-126), and searching for rows pointed to by the selected index for rows satisfying the other criterion. Thus, the index may be dynamically selected and switched as needed, as often as on a row-by-row basis of the source table.

FIG. 2A illustrates a variation on the process of FIG. 2 wherein greater efficiency may be achieved by probing the first and second indexes in parallel, rather than in series. For example, in a multiprocessor system, steps 112, 116 may be performed on a first processor while steps 114 and 118 are being performed concurrently on a second processor. After determining the number of rows satisfying the first criterion (step 116) and the number of rows satisfying the second criterion (step 118), the comparisons (steps 122, 123, etc.) between those two numbers may be performed as previously described with reference to FIG. 2.

The values of the first and second criterion encountered during execution of the query and the resulting selection of indexes may be cached, to further increase performance. Any recurring values for the first or second criteria may then be compared to the cached index selection, to automatically select an index based on the cache, rather than unnecessarily repeating steps such as probing indexes, making comparisons, and re-selecting an index that was previously selected. This is particularly useful when using tables that have many redundant values.

Dynamic index sampling and selection according to the invention can desirably accommodate new indexes created at any time during execution of a query. Thus, if a more optimal index is created while a query is running, the DBMS can selectively sample and switch to the new index, as needed, along with any index available at the outset. Conversely, the DBMS may optionally exclude further use of an index that is consistently determined to be suboptimal. For example, an index that is not selected for an extended period of run time may optionally be omitted in favor of one or more indexes that are more consistently selected as a result of dynamic sampling.

An alternative embodiment would choose the best looking index and start running the join, and then log the fanout (duplicate join candidates) or fanin (discarded join candidates) of the various columns on the right side of the join. The columns which were noted to cause a join probe to be discarded frequently would be desirable to have in an index; whereas columns which were noted to cause fanout would not be desirable to have in the index. The optimizer may then switch mid-query to an index which has the desirable columns if it has more desirable columns than the index is currently using based on the history of the join thus far.

It should be recognized that the invention may be used to perform queries having more than two criteria, and for searching a database having more than two indexes from which to choose. For example, a query may include ten different criterion, each dependent upon column values of a target table and column values of a source table. As many as ten or more indexes may be provided. All of the indexes may be probed to determine the number of rows satisfying the various criteria. The index that points to the fewest number of rows that satisfy the criterion associated with that index may be selected. If more than one index points to the same number of rows, then a tiebreaker can be used. The rows pointed to by the selected index may then be searched to find the subset of rows satisfying all of the other criterion.

For simplicity, many of the examples herein are discussed in terms of database operations performed on two tables, such as a join of two tables. A database typically includes many tables, however. One skilled in the art will recognize that, using the principles herein, the invention may also be used to perform operations on more than two tables, such as a join of three or more tables. For example, if three tables A, B, and C are to be joined, tables A and B may first be joined according to the invention. Then, the table that resulted from the join of tables A and B may be joined with the table C according to the invention.

The invention may contain both hardware and software elements. In particular embodiments, including those embodiments of methods, the invention may be implemented in software, which includes but is not limited to firmware, resident software and microcode.

Furthermore, the invention can take the form of a computer program product accessible from a computer-readable medium providing program code for use by or in connection with a computer or any instruction execution system. For the purposes of this description, a computer-usable or computer readable medium can be any apparatus that can contain, store, communicate, propagate or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

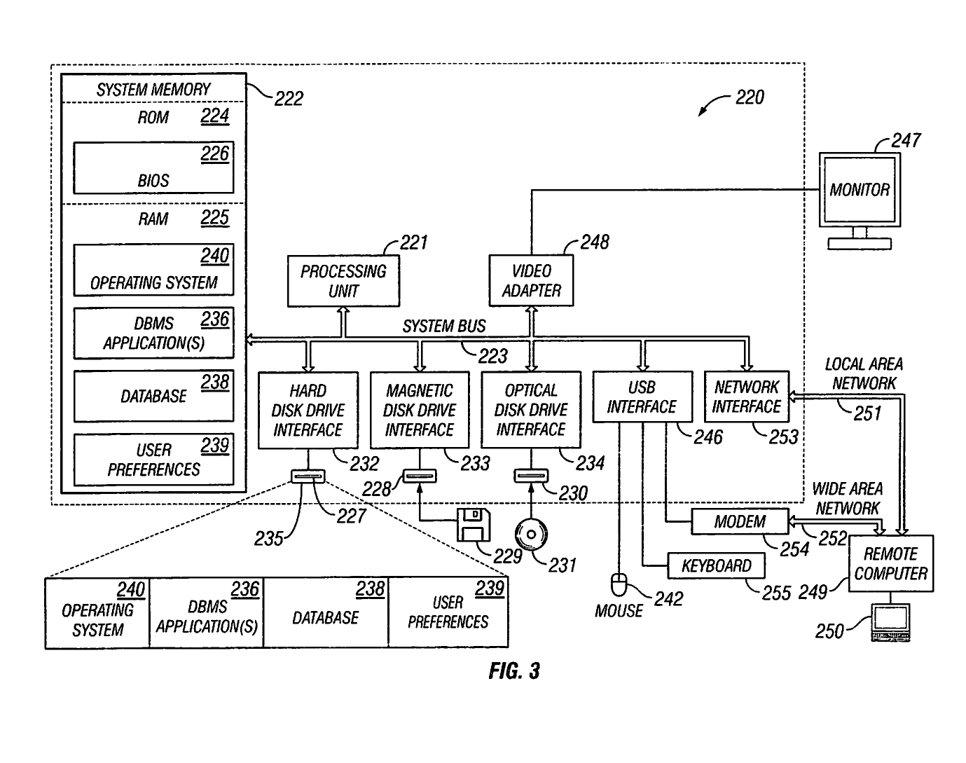

FIG. 3 is a schematic diagram of a computer system that may be configured for running a DBMS software application capable of querying a database according to the invention. Generally, computer system 220 includes a processing unit 221, a system memory 222, and a system bus 223 that couples various system components, including the system memory 222, to processing unit 221. System bus 223 may be any of several types of bus structures including a memory bus or memory controller, a peripheral bus, and a local bus using any of a variety of bus architectures. The system memory includes a read only memory (ROM) 224 and random access memory (RAM) 225. A basic input/output system (BIOS) 226 is stored in ROM 224, containing the basic routines that help to transfer information between elements within computer system 220, such as during start-up.

Computer system 220 further includes a hard disk drive 235 for reading from and writing to a hard disk 227, a magnetic disk drive 228 for reading from or writing to a removable magnetic disk 229, and an optical disk drive 230 for reading from or writing to a removable optical disk 231 such as a CD-R, CD-RW, DV-R, or DV-RW. Hard disk drive 235, magnetic disk drive 228, and optical disk drive 230 are connected to system bus 223 by a hard disk drive interface 232, a magnetic disk drive interface 233, and an optical disk drive interface 234, respectively. Although the exemplary environment described herein employs hard disk 227, removable magnetic disk 229, and removable optical disk 231, it should be appreciated by those skilled in the art that other types of computer readable media which can store data that is accessible by a computer, such as magnetic cassettes, flash memory cards, digital video disks, Bernoulli cartridges, RAMs, ROMs, USB Drives, and the like, may also be used in the exemplary operating environment. The drives and their associated computer readable media provide nonvolatile storage of computer-executable instructions, data structures, program modules, and other data for computer system 220. For example, the operating system 240 and DBMS software application(s) 236 may be stored in the RAM 225 and/or hard disk 227 of the computer system 220.

A user may enter commands and information into computer system 220 through input devices, such as a keyboard 255 and a mouse 242. Other input devices (not shown) may include a microphone, joystick, game pad, touch pad, scanner, or the like. These and other input devices are often connected to processing unit 222 through a USB (universal serial bus) 246 that is coupled to the system bus 223, but may be connected by other interfaces, such as a serial port interface, a parallel port, game port, or the like. A display device 247 may also be connected to system bus 223 via an interface, such as a video adapter 248. In addition to the monitor, personal computers typically include other peripheral output devices (not shown), such as speakers and printers.

The computer system 220 may operate in a networked environment using logical connections to one or more remote computers 249. Remote computer 249 may be another personal computer, a server, a client, a router, a network PC, a peer device, a mainframe, a personal digital assistant, an internet-connected mobile telephone or other common network node. While a remote computer 249 typically includes many or all of the elements described above relative to the computer system 220, only a memory storage device 250 has been illustrated in FIG. 8. The logical connections depicted in the figure include a local area network (LAN) 251 and a wide area network (WAN) 252. Such networking environments are commonplace in offices, enterprise-wide computer networks, intranets, and the internet.

When used in a LAN networking environment, the computer system 220 is often connected to the local area network 251 through a network interface or adapter 253. When used in a WAN networking environment, the computer system 220 typically includes a modem 254 or other means for establishing high-speed communications over WAN 252, such as the internet. Modem 254, which may be internal or external, is connected to system bus 223 via USB interface 246. In a networked environment, program modules depicted relative to computer system 220, or portions thereof, may be stored in the remote memory storage device 250. It will be appreciated that the network connections shown are exemplary and other means of establishing a communications link between the computers may be used.

Program modules may be stored on hard disk 227, optical disk 231, ROM 224, RAM 225, or even magnetic disk 229. The program modules may include portions of an operating system 240, DBMS application(s) 236, or the like. A database 238 is included, which may include data arranged in tabular form, and/or data which may be output in tabular form. In particular, the database 238 may contain a plurality of database tables, from which a suitable target table and any source table(s) may be identified, as in the above-described embodiments of the invention. Data in the database 238 may be input and periodically updated by a user and/or the DBMS application(s) 236. A user preferences database 239 may also be included.

The DBMS application(s) 236 includes computer-executable instructions for querying the Database 238. Methods according to the present invention may be implemented by the DBMS application(s) 236, and optionally according to any user preferences contained within the user preferences database. The DBMS application(s) 236 may be a software application designed exclusively for executing database queries according to the invention. Alternatively, the DBMS application(s) may include a DBMS application for selectively executing database queries in a conventional manner, along with one or more software components for selectively executing database queries according to the invention, such as by implementing dynamic index sampling and selection and other features described above.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of querying a database, comprising:
providing a target table and a source table;
providing a query for selecting rows of the target table that simultaneously satisfy first and second criteria, wherein the first criterion specifies values of a first column of the target table and the second criterion specifies values of a second column of the target table;
generating a plurality of indexes, including at least a first index using the first column of the target table and a second index using the second column of the target table;
for each row of the source table, probing the first index to determine a number of rows of the target table that satisfy the first criterion and probing the second index to determine a number of rows of the target table that satisfy the second criterion; and
dynamically switching between the first and second indexes while executing the query according to the number of rows of the target table that satisfy the first criterion and the number of rows of the target table that satisfy the second criterion.

2. The method of claim 1, wherein the query comprises a join of the target table and the source table, a scalar subselect using the target table and the source table, a derived table using the target table and the source table, a common table expression using the target table and the source table, a user defined function using the target table and the source table, a SQL stored procedure using the target table and the source table, or a subquery using the target table and the source table.

3. The method of claim 1, further comprising dynamically selecting one of the first and second indexes for which fewer rows satisfy the respective one of the first and second criteria.

4. The method of claim 1, further comprising selecting the first index by default when the number of rows satisfying the first criterion is fewer than a predetermined number.

5. The method of claim 1, further comprising selecting the one of the first and second indexes that points to the most table pages already in memory when the number of rows determined to satisfy the first criterion substantially equals the number of rows determined to satisfy the second criterion.

6. The method of claim 1, further comprising selecting the one of the first and second indexes with the smaller byte-size when the number of rows satisfying the first criterion substantially equals the number of rows satisfying the second criterion.

7. The method of claim 1, wherein the step of probing the first index to determine the number of rows that satisfy the first criterion is performed in parallel with the step of probing the second index to determine the number of rows that satisfy the second criterion.

8. A computer program product comprising a computer usable medium including computer usable program code for searching a database, the computer program product including:
computer usable program code for providing a target table and a source table;
computer usable program code for providing a query for selecting rows of the target table that simultaneously satisfy first and second criteria, wherein the first criterion specifies values of a first column of the target table and the second criterion specifies values of a second column of the target table;
computer usable program code for generating a plurality of indexes, including at least a first index using the first column of the target table and a second index using the second column of the target table;
computer usable program code for selecting rows of the source table and, for each selected row, probing the first index to determine a number of rows of the target table satisfy the first criterion and probing the second index to determine a number of rows of the target table satisfy the second criterion; and
computer usable program code for dynamically switching between the first and second indexes while executing the query according to the number of rows of the target table that satisfy the first criterion and the number of rows of the target table that satisfy the second criterion.

9. The computer program product of claim 8, wherein the query comprises a join of the target table and the source table, a scalar subselect using the target table and the source table, a derived table using the target table and the source table, a common table expression using the target table and the source table, a user defined function using the target table and the source table, a SQL stored procedure using the target table and the source table, or a subquery using the target table and the source table.

10. The computer program product of claim 8, further comprising computer usable program code for dynamically selecting one of the first and second indexes for which fewer rows satisfy the respective one of the first and second criteria.

11. The computer program product of claim 8, further comprising computer usable program code for selecting the first index by default when the number of rows satisfying the first criterion is fewer than a predetermined number.

12. The computer program product of claim 8, further comprising computer usable program code for selecting the one of the first and second indexes that points to the most table pages already in memory when the number of rows determined to satisfy the first criterion substantially equals the number of rows determined to satisfy the second criterion.

13. The computer program product of claim 8, further comprising computer usable program code for selecting the one of the first and second indexes with the smaller byte-size when the number of rows satisfying the first criterion substantially equals the number of rows satisfying the second criterion.

14. The computer program product of claim 8, wherein probing the first index to determine how many rows satisfy the first criterion is performed in parallel with the step of probing the second index to determine how many rows satisfy the second criterion.

15. The computer program product of claim 14 wherein the step of probing the first index to determine the number of rows that satisfy the first criterion is performed in parallel with the step of probing the second index to determine the number of rows that satisfy the second criterion.

16. A method, comprising:
providing a database having a plurality of tables;
designating a target table and a source table;
providing a plurality of indexes to the target table;
providing a query for operating on the target table and the source table;
selecting values from the source table as specified in the query on a row-by-row basis;
dynamically selecting the indexes for the selected values of the source table according to how many rows of the target table are pointed to by each index; and
using the selected indexes to perform operations specified by the query.

17. The method of claim 16, wherein the query comprises a join of the target table and the source table, a scalar subselect using the target table and the source table, a derived table using the target table and the source table, a common table expression using the target table and the source table, a user defined function using the target table and the source table, a SQL stored procedure using the target table and the source table, or a subquery using the target table and the source table.

18. The method of claim 16, wherein the step of dynamically selecting one of the indexes further comprises selecting one of the indexes pointing to the fewest rows of the target table.

19. The method of claim 16, wherein the step of selecting one of the indexes comprises selecting one of the indexes pointing to fewer than a predetermined number of rows of the target table.

20. A method of dynamically selecting indexes during the execution of a database query, comprising:
providing a target table and a source table;
providing a query for selecting rows of the target table that simultaneously satisfy first and second criteria, wherein the first criterion specifies values of a first column of the target table and the second criterion specifies values of a second column of the target table;
generating a plurality of indexes, including at least a first index using the first column of the target table and a second index using the second column of the target table;
for each row of the source table, probing the first index to determine a number of rows of the target table that satisfy the first criterion, probing the second index to determine a number of rows of the target table that satisfy the second criterion, and selecting one of the first and second indexes for which fewer rows satisfy the respective one of the first and second criteria; and
for each row of the source table, selecting rows of the target table according to the query using the selected index.
